(19) United States
(12) Patent Application Publication
(10) Pub. No.: US 2009/0227344 A1
(43) Pub. Date: Sep. 10, 2009

(54) Gaming Machine Including a Reel with a New Configuration for Variably Displaying a Plurality of Symbols

(75) Inventor: Kazumasa YOSHIZAWA, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: Aruze Corp., Tokyo (JP)

(21) Appl. No.: 12/372,214

(22) Filed: Feb. 17, 2009

Related U.S. Application Data
(60) Provisional application No. 61/034,408, filed on Mar. 6, 2008.

(51) Int. Cl. A63F 9/24; A63F 13/00

(52) U.S. Cl. 463/20; 463/40

(57) ABSTRACT

The gamine machine 10 executes the following processing of: starting a basic game; starting scrolling of symbols displayed on the liquid crystal display 30; determining symbols to display stationarily; rearranging the stationary symbols thus determined on the liquid crystal display 30; in a case where the symbol combination rearranged on winning lines L1 to L8 which combine symbols included in the first symbol group set on the crystal display 30 in advance matches a predetermined combination, providing a predetermined award to a player; and furthermore, in a case where a symbol of the second symbol group which indicates a payout rate of an award is rearranged on the extended line of the winning line on which the predetermined combination is formed, further providing an award to a player which equals the predetermined award multiplied by the payout rate indicated by the symbol

### CROSS REFERENCE TO RELATED APPLICATIONS

This application claims benefit of U.S. Provisional Application No. 61/034,408, filed Mar. 6, 2008, the entire contents of which are incorporated herein by reference.

### BACKGROUND OF THE INVENTION

1. Field of the Invention

The present invention relates to a gaming machine that includes a new reel configuration.

2. Related Art

It is known that conventional slot machines start a game when a predetermined amount of credit is bet and then a plurality of reels, on which a plurality of symbols are depicted, start to rotate and the rotations of the plurality of the reels stop after a predetermined period of time elapses. As a result, an award is provided to a player based on a displayed stationary symbol combination. U.S. Pat. No. 6,517,433 discloses that, to improve a shortcoming of common expressions lacking dynamism on a display, a video display is provided in front of rotatable reels to provide a video image superimposed upon the rotatable reels thereby displaying visual effects including information associated with games correlating with the images of reels, whereby novel and powerful effects are produced in games. Furthermore, the slot machine disclosed in U.S. Pat. No. 5,823,874 includes reels and roulette, and provides an award based on a symbol combination which is displayed statically and the payout rate determined by the roulette.

However, although the former slot machine described above produces novel and powerful effects in games by providing a video display, the configuration of reels is still the same as that of conventional slot machines and the game tends to lack in variety. Furthermore, although the latter slot machine also includes roulette to determine the payout rate, the reel itself is the same as that of conventional slot machines. Thus, a gaming machine which is provided with a reel configuration that has not existed thus far is expected.

The present invention provides a gaming machine that includes a new reel configuration which has is not existed thus far, and has new entertainment properties which provide an award according to the configuration of the reel which is not existed thus far, thereby arousing a player's interest and can enhancing excitement.

### SUMMARY OF THE INVENTION

In a first aspect of the present invention, a gaming machine includes: a display for displaying each of a first symbol group and a second symbol group having a plurality of symbols used in a game, the second symbol group arranged to be adjacent to the first symbol group; an input device for starting a basic game; and a controller configured to execute the following processing of: (a) generating a random number in response to an input to the input device and starting a basic game; (b) starting scrolling of the symbols displayed on the display; (c) determining a symbol to stationarily display on the display corresponding to the random number thus generated; (d) rearranging the symbols thus determined by displaying the symbols stationarily on the display corresponding to the processing of (c); (e) providing a predetermined award to a player in a case where a combination of the symbols rearranged on a winning line, which combines symbols included in the first symbol group, set on the display in advance matches a predetermined combination; and (f) in addition to the processing of (e), in a case where a symbol indicating a payout rate of the award among the rearranged symbols of the second symbol group is rearranged on an extended line of the winning line on which the predetermined combination is formed, further providing an award to the player which equals the predetermined award multiplied by the payout rate of the award indicated by the symbol.

The gaming machine according to the first aspect of the present invention includes: a display for displaying each of a first symbol group and a second symbol group having a plurality of symbols used in a game, the second symbol group arranged to be adjacent to the first symbol group; an input device for starting a basic game; and a controller configured to execute the following processing of: (a) generating a random number in response to an input to the input device and starting a basic game; (b) starting scrolling of the symbols displayed on the display; (c) determining a symbol to stationarily display on the display corresponding to the random number thus generated; (d) rearranging the symbols thus determined by displaying the symbols stationarily on the display corresponding to the processing of (c); (e) providing a predetermined award to a player in a case where a combination of the symbols rearranged on a winning line, which combines symbols included in the first symbol group, set on the display in advance matches a predetermined combination; and (f) in addition to the processing of (e), in a case where a symbol indicating a payout rate of the award among the rearranged symbols of the second symbol group is rearranged on an extended line of the winning line on which the predetermined combination is formed, further providing an award which equals the predetermined award multiplied by the payout rate of the award indicated by the symbol to the player.

In a second aspect of the present invention, the controller of a gaming machine according to the first aspect is configured to further execute the following processing of: (g) in the rearranging processing of (d), rearranging each of the symbols in the first symbol group, and after a predetermined period of time has elapsed, subsequently rearranging each of the symbols in the second symbol group. The gaming machine according to the second aspect of the present invention includes the controller of the gaming machine according to the first aspect, which is configured to further execute the following processing of: (g) in the rearranging processing of (d), rearranging each of the symbols in the first symbol group, and after a predetermined period of time has elapsed, subsequently rearranging each of the symbols in the second symbol group.

In a third aspect of the present invention, the controller of a gaming machine according to the second aspect is configured to further execute the following processing of: (h) displaying the first symbol group with a frame image for aiding distinction of symbols on the display.

The gaming machine according to the third aspect of the present invention includes the controller of the gaming machine according to the second aspect, which is configured to further execute the following processing of: (h) displaying the first symbol group with a frame image for aiding distinction of symbols on the display.

In a fourth aspect of the present invention, a gaming machine includes: a display for displaying each of a first symbol group and a second symbol group having a plurality of symbols used in a game, the second symbol group arranged to be adjacent to the first symbol group; an input device for starting a basic game; and a controller configured to execute the following processing of: (a) generating a random number in response to an input to the input device and starting a basic game; (b) starting scrolling of the symbols displayed on the display; (c) determining a symbol to stationarily display on the display corresponding to the random number thus generated; (d) rearranging the symbols thus determined by displaying symbols stationarily on the display corresponding to the processing of (c); (e) providing a predetermined award to a player in a case where a combination of the symbols rearranged on a winning line, which combines symbols included in the first symbol group, set on the display in advance matches a predetermined combination; and (f) in addition to the processing of (e), in a case where a combined combination of the rearranged symbols of the first symbol group forming the predetermined combination on the winning line and the symbols of the second symbol group rearranged on an extended line of the winning line on which the predetermined combination is formed matches a predetermined combination, further providing a predetermined award to the player.

The gaming machine according to the fourth aspect of the present invention includes: a display for displaying each of a first symbol group and a second symbol group having a plurality of symbols used in a game, the second symbol group arranged to be adjacent to the first symbol group; an input device for starting a basic game; and a controller configured to execute the following processing of: (a) generating a random number in response to an input to the input device and starting a basic game; (b) starting scrolling of the symbols displayed on the display; (c) determining a symbol to stationarily display on the display corresponding to the random number thus generated; (d) rearranging the symbols thus determined by displaying symbols stationarily on the display corresponding to the processing of (c); (e) providing a predetermined award to a player in a case where a combination of the symbols rearranged on a winning line, which combines symbols included in the first symbol group, set on the display in advance matches a predetermined combination; and (f) in addition to the processing of (e), in a case where a combined combination of the rearranged symbols of the first symbol group forming the predetermined combination on the winning line and the symbols of the second symbol group rearranged on an extended line of the winning line on which the predetermined combination is formed matches a predetermined combination, further providing a predetermined award to the player.

In a fifth aspect of the present invention, the controller in a gaming machine according to the fourth aspect is configured to further execute the following processing of: (g) in the rearranging processing of (d), rearranging each of the symbols in the first symbol group, and after a predetermined period of time has elapsed, subsequently rearranging each of the symbols in the second symbol group.

The gaming machine according to the fifth aspect of the present invention includes the controller of the gaming machine according to the fourth aspect, which is configured to further execute the following processing of: (g) in the rearranging processing of (d), rearranging each of the symbols in the first symbol group, and after a predetermined period of time has elapsed, subsequently rearranging each of the symbols in the second symbol group.

In a sixth aspect of the present invention, the controller in a gaming machine according to the fifth aspect is configured to further execute the following processing of: (h) displaying the first symbol group with a frame image for aiding distinction of symbols on the display.

The gaming machine according to the sixth aspect of the present invention includes the controller of the gaming machine according to the fifth aspect, which is configured to further execute the following processing of: (h) displaying the first symbol group with a frame image for aiding distinction of symbols on the display.

### BRIEF DESCRIPTION OF THE DRAWINGS

FIG. 1 is a diagram showing characteristics of the gaming machine according to an embodiment of the present invention. The diagram is showing an example of a display screen displayed by the gaming machine;

FIG. 2 is a perspective view showing an appearance of the gaming machine according to the embodiment of the present invention;

FIG. 3 is an enlarged front view showing a display area of the gaming machine according to the embodiment of the present invention;

FIG. 4 is a block diagram of a controller of the gaming machine according to the embodiment of the present invention;

FIG. 5 is a block diagram of a display control device of the gaming machine according to the embodiment of the present invention;

FIG. 6 is a diagram showing a symbol data table for a first symbol group according to the embodiment of the present invention;

FIG. 7 is a diagram showing columns of symbols depicted on the respective video reels of the gaming machine according to the embodiment of the present invention;

FIG. 8 is a diagram showing a symbol layout table for a second symbol group of the gaming machine according to the embodiment of the present invention;

FIG. 9 is a diagram showing a combination table for a first symbol group of the gaming machine according to the embodiment of the present invention;

FIG. 10 is a diagram showing a payout rate table for a rate symbol of a second symbol group of the gaming machine according to the embodiment of the present invention;

FIG. 11 is a diagram showing a symbol combination table for a combined combination of the symbols of the first symbol group and the symbols of the second symbol group of the gaming machine according to the embodiment of the present invention;

FIG. 12 is a flowchart for a basic game processing executed by the gaming machine according to the embodiment of the present invention;

FIG. 13 is a flowchart of a second award providing processing executed in the gaming machine according to the embodiment of the present invention;

FIG. 14 is a diagram showing a first example of a display screen of a game performed by the gaming machine according to the embodiment of the present invention;

FIG. 15 is an example of a display screen continued from FIG. 14;

FIG. 16 is an example of a display screen continued from FIG. 15;

FIG. 17 is a diagram showing a second example of a display screen of the game performed by the gaming machine according to the embodiment of the present invention; and

FIG. 18 is an example of a display screen continued from FIG. 17.

### DETAILED DESCRIPTION OF THE INVENTION

The embodiments of the present invention are hereinafter described with reference to the attached drawings.

A gaming machine 10 according to the present invention includes a start switch 25 and a CPU 106, which executes the following operation of: (a) generating a random number in response to an input to the start switch 25, and starting the basic game; (b) starting scrolling of symbols displayed on a liquid crystal display 30; (c) determining a symbol to stationarily display corresponding to the random number thus generated; (d) rearranging the symbol thus determined by displaying a symbol stationarily on the liquid crystal display 30; (e) providing a predetermined award to a player in a case where a combination of the symbols rearranged on winning lines L1 to L8, which combines symbols included in the first symbol group, set on the liquid crystal display 30 in advance matches a predetermined combination; and (f) in addition to the processing of (e), in a case where the symbol indicating a payout rate of the award among the rearranged symbols of the second symbol group, is rearranged on an extended line of the winning line on which the predetermined combination is formed, further providing an award which equals a predetermined award multiplied by the payout rate of the award indicated by the symbol to the player.

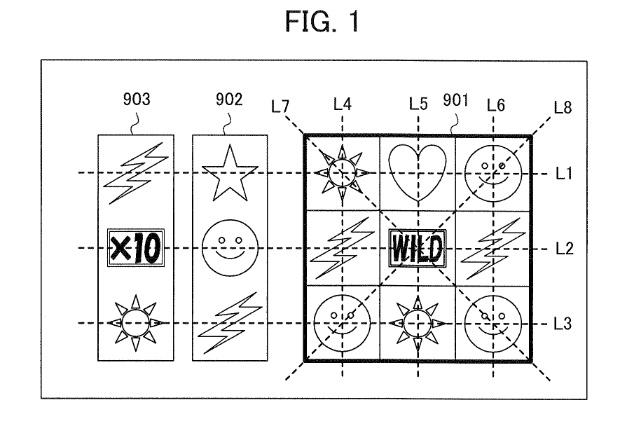

FIG. 1 is a diagram showing characteristics of the gaming machine 10 according to an embodiment of the present invention. In FIG. 1, “900” indicates a display for displaying a plurality of symbols used in a game, “901” indicates a first symbol group, and the “902” indicates a second symbol group. The gaming machine 10 according to the present invention starts a basic game, accordingly rearranges symbols of the first symbol group, and in a case where a combination of the rearranged symbols matches a predetermined condition, provides a predetermined award to a player. Furthermore, as a result of rearranging the second symbol group, in a case where a symbol indicating a payout rate of the award is rearranged on the extended line of winning lines L1 to L8 (for example, L2 in FIG. 1) on which the first symbol group forms a combination that matches the predetermined combination, the gaming machine 10 according to the present invention further provides an award that equals a provided award multiplied by the payout rate.

The gaming machine 10 according to the present invention provides an award based on the combination of the rearranged first symbol group and further provides an award which equals the award multiplied by the payout rate in a case where the symbol indicating a payout rate among the second symbol group is rearranged on the extended line of the winning line on which the predetermined combination is formed, whereby the gaming machine 10 is provided with new entertainment properties that can arouse a player's interest and enhance excitement.

Moreover, the gaming machine 10 according to the present invention provides an award in a case where a combined combination of the rearranged symbols of the first symbol group forming the predetermined combination on the winning line and symbols of the second symbol group rearranged on the extended line of the winning line on which the combination is formed (for example, L2 in FIG. 1) matches the predetermined combination, whereby the gaming machine 10 is provided with new entertainment properties that can arouse a player's interest and enhance excitement.

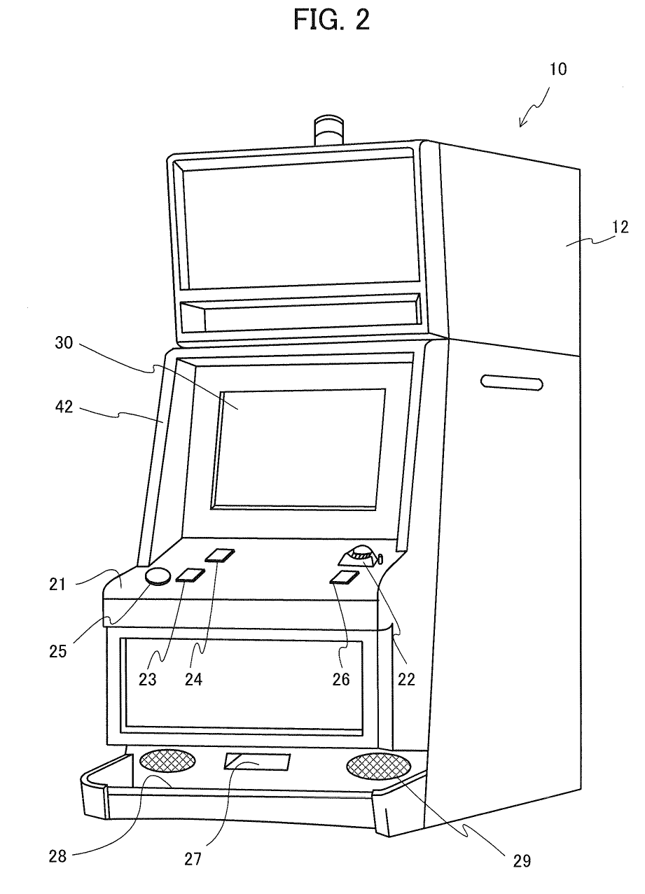

FIG. 2 is a perspective view showing an appearance of the gaming machine 10 according to the embodiment of the present invention.

The gaming machine 10 according to the embodiment of the present invention is described with reference to FIG. 2.

The gaming machine 10 includes a cabinet 12 and a main door 42.

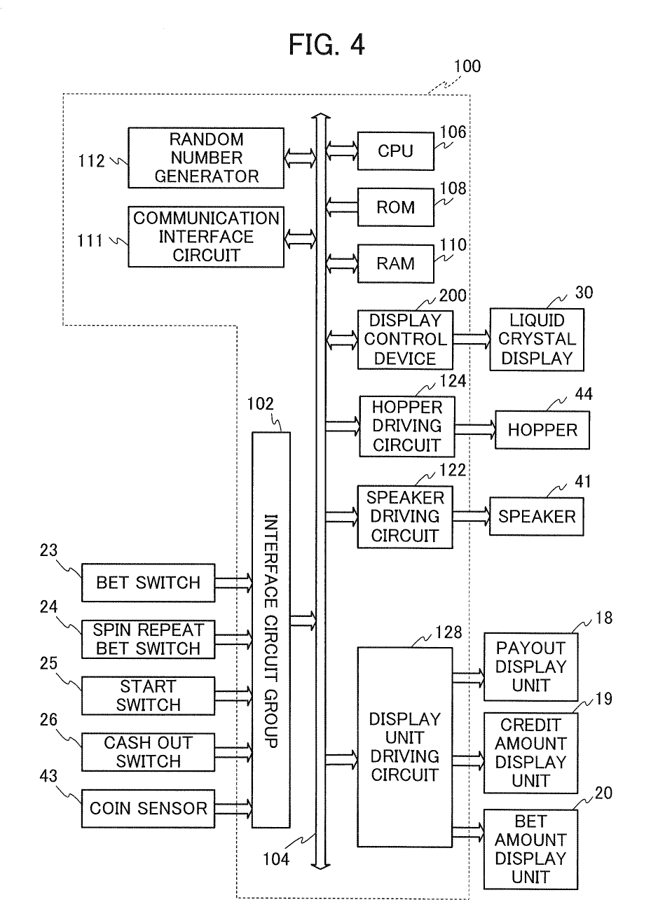

The cabinet 12, which has a surface open to a player, is installed in a certain place of a casino, for example. The cabinet 12 contains various kinds of constructional members, including members such as a controller 100 (see FIG. 4) for electrically controlling the gaming machine 10, and a hopper 44 (see FIG. 4) for controlling the inserting, storing and paying of coins (game media).

The main door 42 serves as a member which covers the cabinet 12 so as to protect the inside components of the cabinet 12 from being exposed to the outside. The main door 42 is attached to a left side of the cabinet 12 about an axis as seen from the front side, so that the door 42 swings about the axis in the forward and backward directions, and settles in either a selectable open or closed positions. The liquid crystal display 30 is disposed substantially in the center of the main door 42.

The liquid crystal display 30 is a display means for displaying various kinds of images associated with a game, and the player advances the game while visually confirming the various kinds of images thus displayed on the liquid crystal display 30. It should be noted that a detailed description regarding the configuration of the liquid crystal display 30 is given later.

A substantially horizontal operation unit 21 is provided below the liquid crystal display 30. A coin insertion opening 22, which allows the player to insert coins into the gaming machine 10, is provided on the right side of the operation unit 21. On the other hand, a bet switch 23 for selecting the amount of coins to bet on a single game and a spin repeat bet switch 24 for playing the subsequent game without changing the amount of coins to bet from the amount of coins bet in a previous game are disposed on the left side of the operation unit 21. Such an arrangement allows the player to determine the amount of coins to bet on a single game by pushing either the bet switch 23 or the spin repeat bet switch 24.

A start switch 25 is disposed on the left side of the bet switch 23 on the operation panel 21. At the start of each game, the start switch 25 receives an instruction given by the player for starting a game. A pushing operation of either the start switch 25 or the spin repeat bet switch 24 triggers starting of the game.

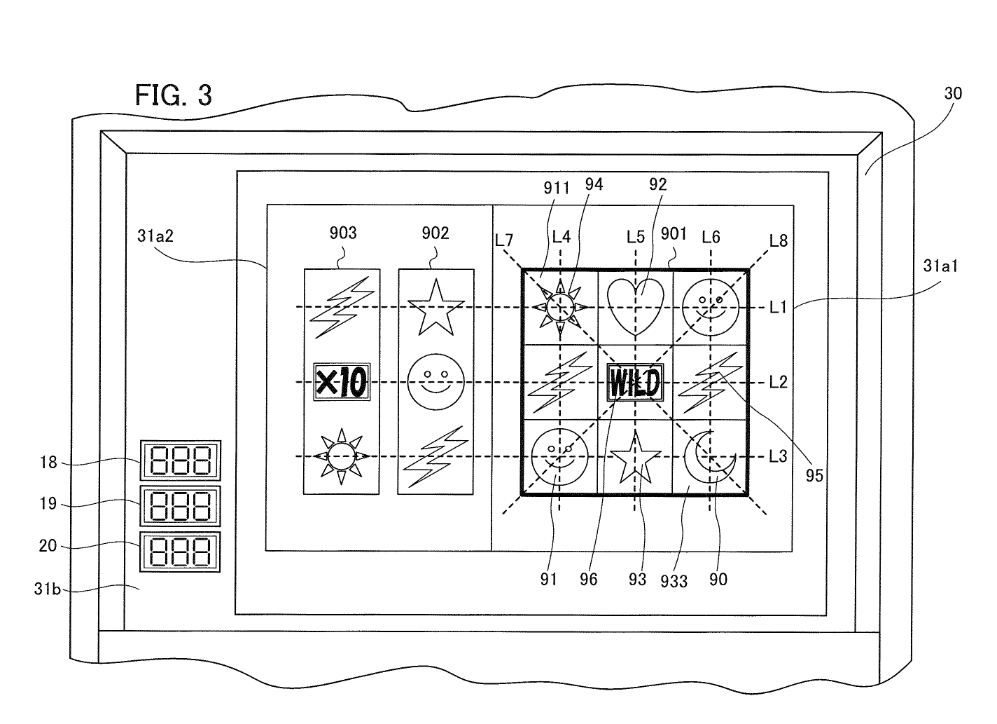

A payout switch 26 is disposed adjacent to the coin insertion slot 22 on the operation panel 21. Upon a pushing operation of the payout switch 26 by the player, coins in the gaming machine 10 are paid out through a coin payout opening 27 disposed at the lower portion of the front face of the main door 42 into a coin tray 28. Sound outlets 29 for conveying sound effects generated by speakers 41 (see FIG. 3), which are contained inside of the cabinet 12, to the outside of the cabinet 12, are disposed on both the right and left sides of the coin payout opening 27 above the coin tray 28.

Moreover, it should be noted that, although the gaming machine 10 according to the present embodiment employs a coin as a game medium, the game medium is not limited thereto, and any kind of game medium such as cash, a medal, a token, electronic money, a ticket, an IC card, and the like may be used, for example.

FIG. 3 is an enlarged front view showing a display area of the gaming machine 10 according to the embodiment of the present invention.

The liquid crystal display 30 is described with reference to FIG. 3.

The liquid crystal display 30 is configured with a publicly known liquid crystal display and includes a display screen 31a1, a display screen 31a2, and a display screen 31b. The display screen 31a1 displays cells 911 to 933 arranged in a matrix as a display area of the first symbol group. The display screen 31a2 displays a center reel 902 and a left reel 903 as a display area of the second symbol group. The display screen 31b includes a payout amount display unit 18, a credit amount display unit 19, and a bet amount display unit 20. The cells 911 to 933 are the basic unit of the display arranged in a matrix provided on the display screen 31a1.

The display screen 31a1 displays the cells 911 to 933 which are divided into matrix of 3 rows and 3 columns, as the first symbol group. Here, the cell 911 indicates the cell positioned in row 1 and column 1 and the cell 933 indicates the cell positioned in row 3 and the column 3. On each of the cells 911 to 933, a moon symbol 90, a smile symbol 91, a heart symbol 92, a star symbol 93, a sun symbol 94, a thunder symbol 95, and a wild symbol 96 is displayed.

The first symbol group includes eight winning lines L1 to L8 for providing an award as shown in FIG. 3. The winning lines L1 to L8 for providing each award are extended so as to pass through one symbol in each of the cells 911 to 933 when symbols are rearranged in each of the cells 911 to 933. Specifically, the first symbol group includes a winning line L1 combining cells 911, 912 and 913, a winning line L2 combining cells 921, 922 and 923, a winning line L3 combining cells 931, 932 and 933, a winning line L4 combining cells 911, 921 and 931, a winning line L5 combining cells 912, 922 and 932, a winning line L6 combining cells 913, 923 and 933, a winning line L7 combining cells 911, 922 and 933, and a winning line L8 combining cells 913, 922 and 931.

Upon the player pushing the bet switch 23 once, the winning lines L1 to L3 are activated and one coin is spent as a credit medal, for example.

Furthermore, upon the player pushing the bet switch 23 twice, the winning lines L4 to L6 are activated in addition to the aforementioned 3 pay lines, and two coins are spent as credit medals, for example.

Moreover, upon the player pushing the bet switch 23 three times, the winning lines L7 and L8 are activated in addition to the aforementioned six winning lines, and three coins are spent as credit medals, for example.

Video reels 902 and 903 are displayed on the display screen 31a2 as the second symbol group. On the video reels 902 and 903, a moon symbol 90, a smile symbol 91, a heart symbol 92, a star symbol 93, a sun symbol 94 and a thunder symbol 95 as well as a rate symbols including a double symbol 97, a 5 times symbol 98, and a 10 times symbol 99 are displayed. As shown in FIG. 3, the winning lines L1 to L3 of the first symbol group are extended onto the video reels 902 and 903.

The payout amount display unit 18 on the display screen 31b displays an amount of an award to be paid out in a case where a combination of displayed stationary symbols matches a predetermined combination. The credit amount display unit 19 displays the credit amount which the player currently possesses. The bet amount display unit 20 displays the amount of coins bet by the player (a bet amount) on a single game. In other words, the bet amount which indicates an amount of coins bet on the abovementioned winning lines is displayed. Each of the display units 18 to 20 includes a seven-segment display. Alternatively, the display units 18 to 20 may be used for displaying images.

FIG. 4 is a block diagram of a controller of the gaming machine 10 according to the embodiment of the present invention.

The electrical configuration of the gaming machine 10 is described with reference to FIG. 4.

The abovementioned controller 100 is a microcomputer, which includes an interface circuit group 102, an input/output bus 104, a CPU 106, ROM 108, RAM 110, a communication interface circuit 111, a random number generator 112, a speaker driving circuit 122, a hopper driving circuit 124, a display unit driving circuit 128, and a display control device 200.

The interface circuit group 102 is electrically connected with the input/output bus 104, which inputs and outputs data signals and address signals to and from the CPU 106.

The start switch 25 is electrically connected with the interface circuit group 102. The start signal generated by the start switch 25 is converted into a predetermined form of signal in the interface circuit group 102, to be supplied to the input/output bus 104.

The bet switch 23, the spin repeat bet switch 24, and the payout switch 26 are also electrically connected with the interface circuit group 102. Each of the switching signals output from these switches 23, 24, and 26 is also supplied to the interface circuit group 102, and is converted into a predetermined form of signal by the interface circuit group 102, and the switching signals thus converted are subsequently supplied to the input/output bus 104.

A coin sensor 43 is also electrically connected with the interface circuit group 102. The coin sensor 43 which is disposed at an appropriate position relative to the coin insertion slot 22 is a sensor for detecting detects coins inserted into the coin insertion slot 22. The sensing signal output from the coin sensor 43 is also supplied to the interface circuit group 102, and is converted into a predetermined form of signal by the interface circuit group 102, and the sensing signal thus converted is subsequently supplied to the input/output bus 104.

Furthermore, the ROM 108 and the RAM 110 are connected to the input/output bus 104.

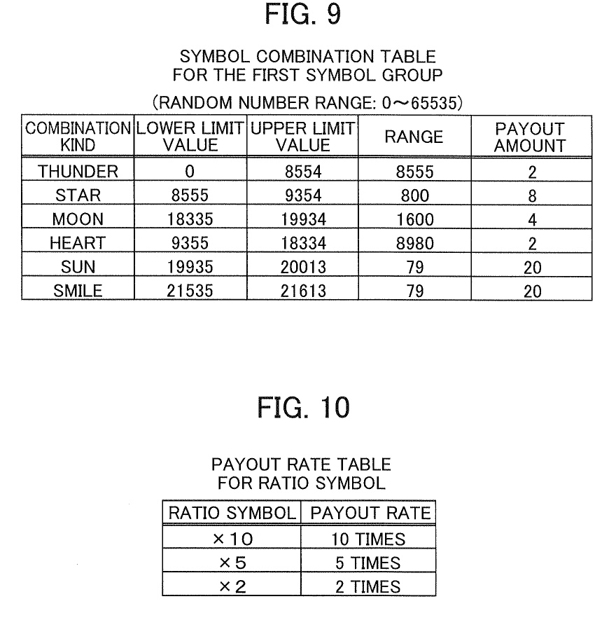

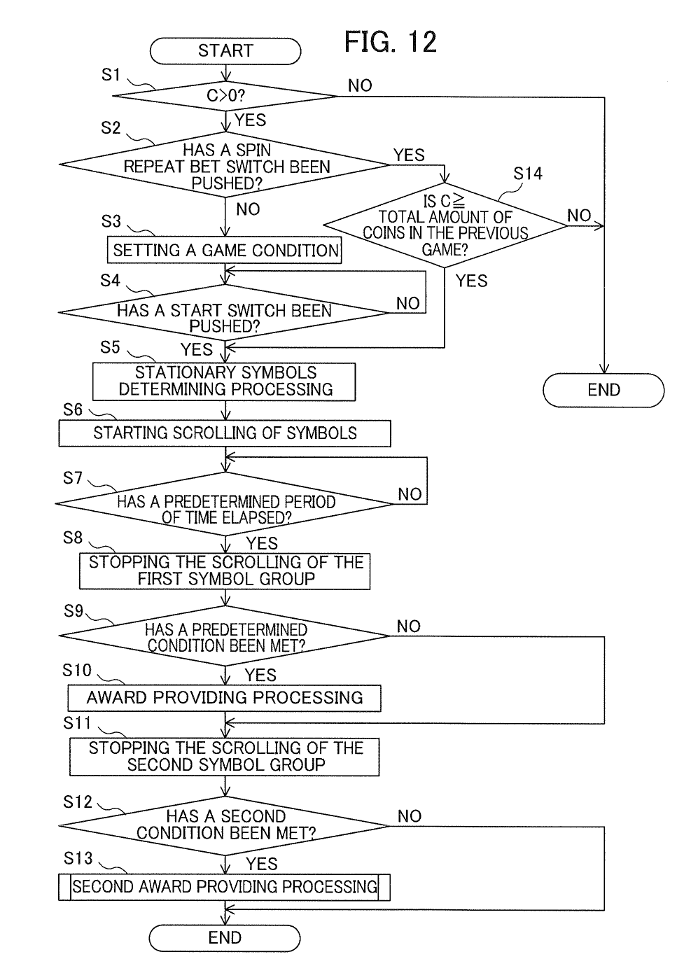

Upon accepting an instruction for starting a basic game via the start switch 25, the CPU 106 reads a game program and performs a basic game. The ROM 108 stores a control program for centrally controlling the gaming machine 10, a program for executing the routines shown in FIG. 12 (hereinafter referred to as “routine program”), initial data for executing the control program, and various data tables. The tables shown in FIGS. 9 to 11 are examples of data tables.

The RAM 110 temporarily stores flags, variables, and the like used for the abovementioned control program.

The communication interface circuit 111 is also connected to the input/output bus 104. The communication interface circuit 111 communicates with a server and the like via various kinds of communication networks, including a public telephone line network, a LAN, and the like.

The random number generator 112 for generating a random number is also connected to the input/output bus 104. The random number generator 112 generates random numbers lying in a predetermined range of for example, 0 to 65535 (two to the sixteenth power minus one). Alternatively, random numbers may be configured to be generated by the processing of the CPU 106.

The display unit driving circuit 128 for driving the abovementioned various display units 18 to 20 is electrically connected with the input/output bus 104. The CPU 106 controls the various display units 18 to 20 via the display unit driving circuit 128 in response to occurrences of predetermined events.

The speaker driving circuit 122 for driving the speaker 41 is also electrically connected with the input/output bus 104. The CPU 106 reads sound data stored in the ROM 108, and transmits the sound data thus read to the speaker driving circuit 122 via the input/output bus 104. In this way, the speaker 41 generates predetermined sound effects.

The hopper driving circuit 124 for driving the hopper 44 is also electrically connected with the input/output bus 104. The CPU 106 outputs a driving signal to the hopper driving circuit 124 via the input/output bus 104 in response to receiving a payout signal from the payout switch 26. Accordingly, the hopper 44 pays out amount of coins equivalent to the current amount of credits remaining, which is stored in a predetermined memory area of the RAM 110.

The display control device 200 is also electrically connected with the input/output bus 104. The CPU 106 generates an instruction for displaying an image according to the status and outcome of a game and outputs an instruction for displaying images thus generated to the display control device 200 via the input/output bus 104. Upon reception of an image display instruction from the CPU 106, the display control device 200 generates a driving signal for driving the liquid crystal display 30 according to the image display instruction thus input, and outputs the generated driving signal to the liquid crystal display 30.

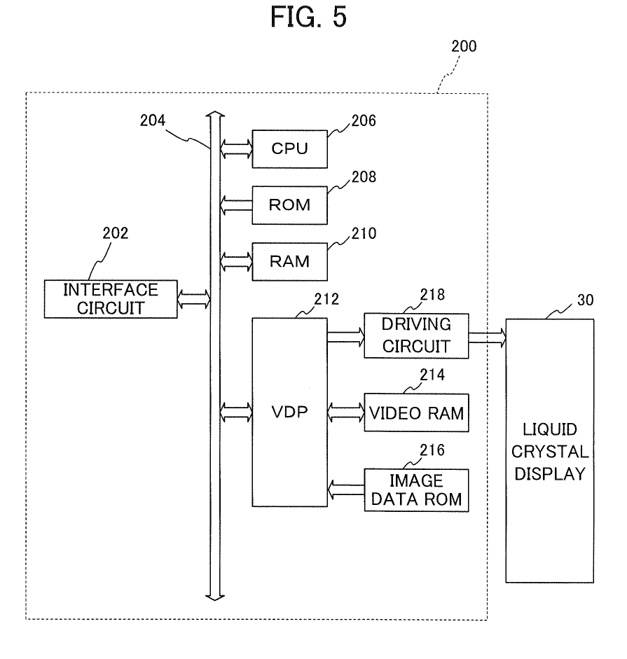

FIG. 5 is a block diagram of a display control device 200 of the gaming machine 10 according to the embodiment of the present invention. The electric configuration of the display control device 200 is described with reference to FIG. 5.

The abovementiond display control device 200 is a sub-microcomputer for executing image displaying processing, and includes an interface circuit 202, an input/output bus 204, a CPU 206, ROM 208, RAM 210, a VDP 212, video RAM 214, image data ROM 216, and a driving circuit 218.

The interface circuit 202 is connected to the input/output bus 204. An instruction for displaying an image generated by the CPU 106 of the controller 100 is output to the input/output bus 204 via the interface circuit 202. The input/output bus 204 inputs and outputs data signals and address signals to and from the CPU 206.

The ROM 208 and the RAM 210 are also connected to the input/output bus 204. The ROM 208 stores a display control program for generating a driving signal to be supplied to the liquid crystal display 30, according to an image display instruction received from the CPU 106 included in the abovementioned controller 100. On the other hand, the RAM 210 stores flags and variables used by the abovementioned program for controlling display.

The VDP 212 is also connected to the input/output bus 204. The VDP 212 includes a so-called sprite circuit, a screen circuit, a palette circuit, and the like, and can execute various kinds of processing for displaying images on the liquid crystal display 30. The video RAM 214 for storing the image data according to an instruction from the CPU 106 of the controller 100, and the image data ROM 216 for storing various image data (including image data of symbols) are connected with the VDP 212. Further, the driving circuit 218 for outputting a driving signal for driving the liquid crystal display 30 is also connected to the VDP 212.

The CPU 206 reads the image data of various symbols from the image data ROM 216 via the VDP 212 in response to receiving an instruction for displaying the image from the CPU 106 of the controller 100, and stores the data thus read to the predetermined memory area of the video RAM 214 which corresponds to the displaying position. The CPU 206 supplies this data to the driving circuit 218 as display signals via the VDP 212, whereby cells 911 to 933 are displayed on the display screen 31a1 and the video reels 902 and 903 are displayed on the display screen 31a2. In addition, the CPU 206 sequentially rewrites the image data of symbols to be stored in the video RAM 214 via the VDP 212, whereby the symbols to be displayed in the cells 911 to 933 are variably displayed on the display screen 31a1 and the symbols to be displayed on the video reels 902 and 903 are variably displayed on the display screen 31a2.

As explained above, it is understood that various processing described in the appended claims are executed by the controller 100 which includes the CPU 106 for executing various kinds of controls in accordance with the program stored in the ROM 108 for storing the routine execution program, the RAM 110 for serving as a working area for CPU 106, and the display control device 200 for controlling driving of the liquid crystal display 30. In other words, the controller 100 serves as an example of a game controller.

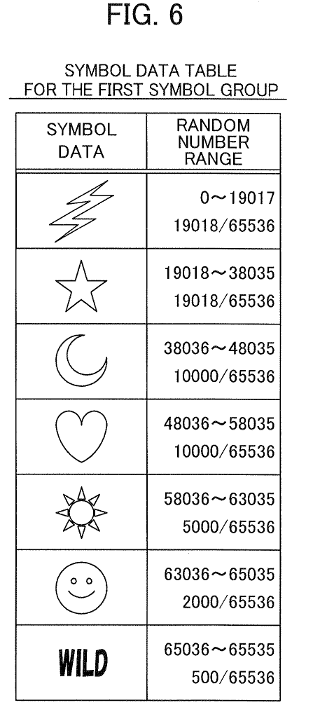

FIG. 6 is a diagram showing a symbol data table for a first symbol group according to the embodiment of the present invention. The symbol data table for a first symbol group includes columns of “Symbol Data” and “Random Number Range”. “Symbol Data” shows the symbol data that is to be rearranged in cells 911 to 933 on the display screen 31a1. “Random Number Range” is probability for rearranging each of symbols in each of the cells. In other words, the CPU 106 determines a symbol to display stationarily according to the random number thus generated.

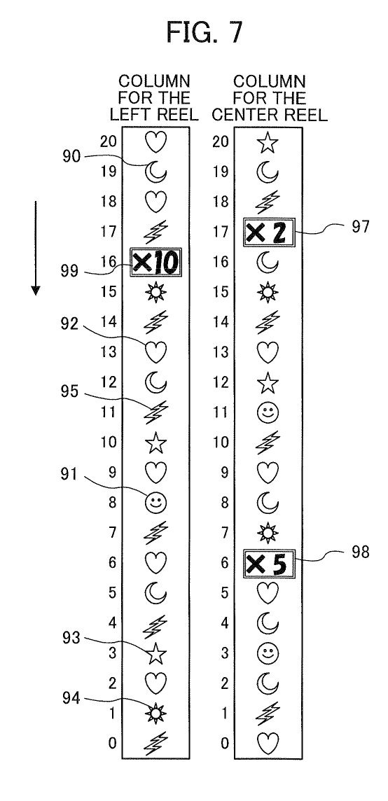

FIG. 7 is a diagram showing columns of symbols depicted on the respective video reels of the gaming machine 10 according to the embodiment of the present invention. FIG. 7 shows columns of 21 symbols arranged on the video reels 902 and 903. The column for the left reel corresponds to the video reel 903 and the column for the center reel corresponds to the video reel 902.

In FIG. 7, code numbers of “00” to “20” refer to each symbol on the video reels 902 and 903. These code numbers are stored in the abovementioned ROM 108 (FIG. 4) in the form of a data table.

The symbol columns on each video reels 902 and 903 are moved by displaying an image in which the reels 902 and 903 are scrolling in a forward direction.

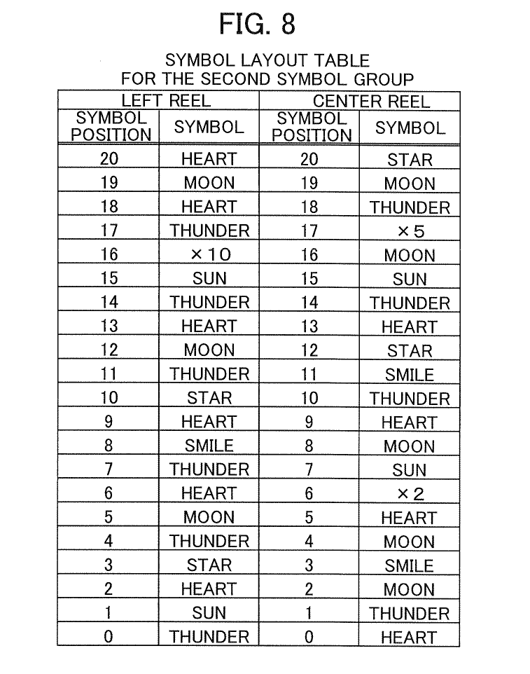

FIG. 8 is a diagram showing a symbol layout table for a second symbol group of the gaming machine 10 according to the embodiment of the present invention. The symbol layout table includes columns of “Code Numbers” indicating a position of each symbol arranged on the symbol columns in relation with each symbol on the video reels 902 and 903.

FIG. 9 is diagram showing a combination table for the first symbol group of the gaming machine 10 according to the embodiment of the present invention. The symbol combination table for the first symbol group includes columns of “Combination Kind”, “Lower Limit Value”, “Upper Limit Value”, “Range”, and “Payout Amount”. The “Combination Kinds” indicates a kind of symbol combination to be rearranged on a winning line. “Lower Limit Value” indicates a lower limit value of a generated random number, “Upper Limit Value” indicates an upper limit value of a generated random number, and “Range” indicates a range between the upper limit value and the lower limit value. In other words, in a case where the generated random number lying in a range of values between the lower limit value and the upper limit value, the combination kind is determined with the corresponding generated random number. “Payout Amount” is an award provided to a player based on the kind of symbol combination rearranged on a winning line.

FIG. 10 is a diagram showing a payout rate table for a rate symbol of the second symbol group of the gaming machine 10 according to the embodiment of the present invention. The payout rate table for the rate symbol includes columns of “Rate Symbol” and a “Payout Rate”. “Rate Symbol” is a symbol which indicates a payout rate of an award among symbols of the second symbol group. “Payout Rate” is a rate of an award corresponding to the rate symbol. In a case where a predetermined condition is met, an award which equals the award multiplied by the payout rate indicated by the rate symbol is provided.

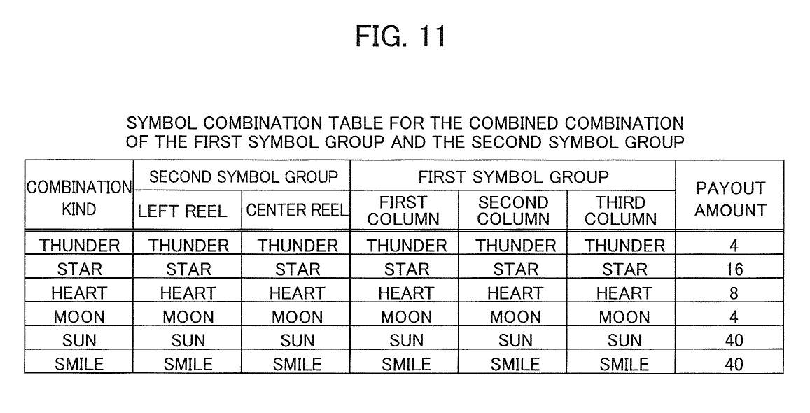

FIG. 11 is a diagram showing a symbol combination table for a combined combination of the symbols of the first symbol group and the symbols of the second symbol group of the gaming machine 10 according to the embodiment of the present invention. The combination table for the combined combination of the first symbol group and the second symbol group includes columns of “Symbols of the First Symbol Group”, “Symbols of the Second Symbol Group”, and “Payout Amount”. “Symbols of the First Symbol Group” indicate a symbol combination of the first symbol group rearranged on the winning line. “Symbols of the Second Symbol Group” indicate a combination of symbols rearranged on an extended line of the winning line on which the first symbol group formed the combination. “Payout Amount” indicates an award that is further provided in a case where the combination is formed.

FIG. 12 is a flowchart showing basic game processing executed in the gaming machine 10 according to the embodiment of the present invention. The routine of FIG. 12 is a unit game.

It is supposed that the gaming machine 10 is activated in advance, and that the variables used in the CPU 106 on the controller 100 are initialized to predetermined values, whereby the gaming machine 10 is operated in a normal state.

The CPU 106 of the controller 100 determines whether or not there are remaining credits, which are remaining coins inserted by a player (Step S1). More specifically, the CPU 106 reads a credit amount C stored in the RAM 110, and executes processing according to the credit amount C thus read. In a case where the credit amount C equals “0” (“NO” in the determination processing in Step S1), the CPU 106 terminates the routine without executing any other processing, since the game cannot be started. On the other hand, in a case where the credit amount C is not less than “1” (“YES” in the determination processing in Step S1), the CPU 106 determines that there is a remaining credit, and the CPU 106 advances the processing to Step S2.

In Step S2, the CPU 106 determines whether or not a pushing operation has been executed on the spin repeat bet switch 24. In a case where the spin repeat bet switch 24 has been pushed and the CPU 106 receives an operation signal from the spin repeat bet switch 24 (“YES” in the determination processing in Step S2), the CPU 106 advances the processing to Step S14. On the other hand, in a case where the CPU 106 does not receive the operation signal from the spin repeat bet switch 24 after the predetermined period of time elapses (“NO” in the determination processing in Step S2), the CPU 106 determines that the spin repeat bet switch 24 has not been pushed and advances the processing to Step S3.

In the following Step S3, the CPU 106 sets the game conditions. More specifically, the CPU 106 determines the amount of coins to be bet in the present game based on the operation of the bet switch 23. Here, the CPU 106 receives the operation signal output in response to the operation of the bet switch 23, and stores the bet amount in a predetermined memory area of the RAM 110 according to the number of times the CPU 106 has received the operation signal. The CPU 106 reads the credit amount C stored in the predetermined memory area of the RAM 110, subtracts the total bet amount, which is the sum of the bet amounts, from the credit amount C thus read, and stores the subtracted value in a predetermined memory area of the RAM 110. Subsequently, the CPU 106 advances the processing to Step S4.

In the following Step S4, the CPU 106 waits for the start switch 25 to be operated by determining whether or not the start switch 25 has been activated. Upon the start switch 25 being operated, and accordingly, upon the operation signal being input from the start switch 25 (“YES” in the determination processing in Step S4), the CPU 106 determines that the start switch 25 has been operated, and the CPU 106 advances the processing to Step S5.

On the other hand, in Step S14, the CPU 106 determines whether or not the credit amount C is equal to or greater than the total bet amount in a previous game. In other words, the CPU 106 determines whether or not the CPU 106 can start a game in response to a pushing operation executed on the spin repeat bet switch 24. Specifically, when the spin repeat bet switch 24 has been pushed, and the operation signal has been input to the CPU 106 from the spin repeat bet switch 24, the CPU 106 reads the credit amount C and the credit amount bet in the previous game stored in the RAM 110. Then, the CPU 106 determines whether or not the credit amount C is equal to or greater than the total credit amount bet in the previous game based on the relation between the credit amount C and the bet amounts thus read, and executes processing based on the determination results. In a case where the CPU 106 determines that the abovementioned credit amount C is less than the total bet amount in the previous game (“NO” in the determination processing in Step S14), the CPU 106 terminates the routine without executing any other processing since the CPU 106 cannot start a game. On the other hand, in a case where the CPU 106 determines that the credit amount C is equal to or greater than the total bet amount in the previous game (“YES” in the determination processing in Step S14), the CPU 106 subtracts the total bet amount in the previous game from the credit amount C, and stores the subtracted value in a predetermined area of the RAM 110. Subsequently, the CPU 106 advances the processing to Step S5.

In Step S5, the CPU 106 executes processing for determining a stationary symbol. The specific contents of the processing for determining a stationary symbol are as follows, for example.

In regards to the first symbol group, the CPU 106 extracts a random number from the random number generator 112. Then, the CPU 106 determines the combination of the stationary symbols to be formed on the winning lines L1 to L8 with the random number extracted according to the combination table for the first symbol group. In a case where the combination thus determined is the specified combination for providing an award, the CPU 106 activates a flag for providing an award. The activated flag, which indicates an award is to be provided, is stored in a predetermined area of the RAM 110 by the CPU 106. On the other hand, in a case where the combination of the stationary symbols to be formed on the winning lines L1 to L8 matches any one of the other combinations, that are the losing combinations, the CPU 106 does not activate the flag which indicates that an award is to be provided. Then, the CPU 106 reads payout rate setting data so as to be stored in the RAM 110, refers to the symbol weighing data corresponding to the payout rate setting data, and determines symbols of each cells 911 to 913 based on the random numbers thus selected.

In regards to the second symbol group, the CPU 106 extracts a random number from the random number generator 112 and then selects random numbers corresponding to each of the two video reels 902 and 903 among a random number range of 0 to 255. Then, the CPU 106 refers to the symbol weighing data corresponding to the payout rate setting data and determines code numbers (see FIG. 8) for each video reels 902 and 903 based on the two random numbers thus selected. The code numbers selected for each video reels 902 and 903 correspond to the symbol code numbers of the symbols which are to be rearranged along the winning line L2. Subsequently, the CPU 106 advances the processing to Step S6.

In Step S6, the CPU 106 displays an image in which cells 911 to 933 of the first symbol group and the video reels 902 and 903 of the second symbol group start to scroll, and then advances processing to Step S7. In Step S7, the CPU 106 waits for a predetermined period of time to elapse. When the predetermined period of time has elapsed (“YES” in the determination processing in Step S7), the CPU 106 advances the processing to Step S8. In Step S8, the CPU 106 automatically stops scrolling of the cells 911 to 933. Subsequently, the CPU 106 advances the processing to Step S9.

In Step S9, the CPU 106 determines whether or not a predetermined symbol combination has been formed based upon the results of the stationary symbol determination processing performed in Step S5. Specifically, the CPU 106 makes this determination based upon the state of the flag which indicates that the award is to be provided with respect to the winning lines stored in the predetermined memory area of the RAM 110. In a case where the flag, which indicates that the award is to be provided, has not been activated, in other words, in a case where the symbol combination matches any one of the “other” combinations, which are combinations other than the specified combinations for providing an award (“NO” in the determination processing in Step S9), the CPU 106 determines that the specified combination for providing an award has not been formed, and advances the processing to Step S11. On the other hand, in a case where the flag, which indicates that an award is to be provided, has been activated, in other words, in a case where the symbol combination matches any one of the combinations other than the “other” combinations (“YES” in the determination processing in Step S9), the CPU 106 advances the processing to Step S10.

In Step S10, the CPU 106 executes processing of providing the award. Specifically, based upon the combination table for the first symbol group (FIG. 9), the CPU 106 provides the award corresponding to combination kinds. Subsequently, the CPU 106 advances processing to Step S11.

In Step S11, the CPU 106 stops scrolling of the second symbol group. The CPU 106 stops the scrolling of the first symbol group, and after the predetermined period of time has elapsed, subsequently stops the scrolling of the second symbol group. Subsequently, the CPU 106 advances the processing to Step S12.

In Step S12, the CPU 106 determines whether or not a predetermined symbol combination including the second symbol group has been formed. In a case where the CPU 106 determines that the predetermined symbol combination has been formed, the CPU 106 advances the processing to Step S13, and in a case where the CPU 106 determines that the predetermined symbol combination has not been formed, the CPU 106 terminates the routine.

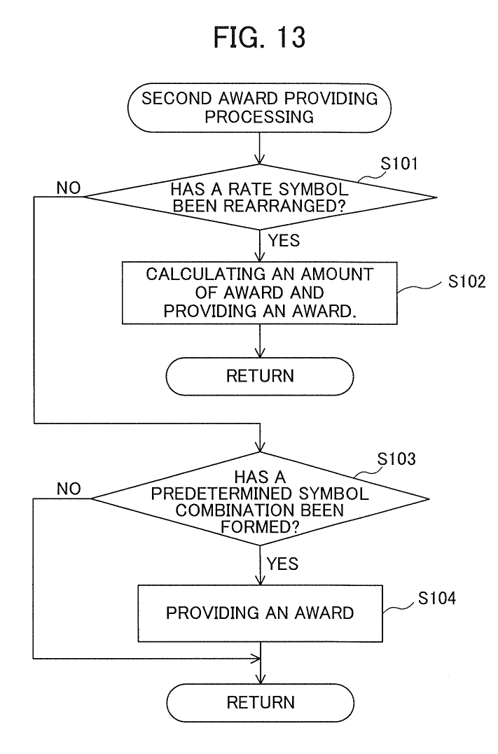

In Step S13, the CPU 106 executes processing for providing the award including the second symbol group. Specifically, the CPU 106 advances the processing to the processing for providing the second award (refer to FIG. 13), and subsequently, terminates the routine.

FIG. 13 is a flowchart of a second award providing processing executed in the gaming machine 10 according to the embodiment of the present invention.

At first, the CPU 106 determines whether or not a rate symbol is rearranged (Step S101). Specifically, the CPU 106 determines whether or not a “2 times” rate symbol 97, a “5 times” rate symbol 98, and a “10 times” rate symbol 99 are rearranged in the second symbol group on the extended line of the winning lines on which the first symbol group forms a predetermined combination. In a case where the CPU 106 determines that the rate symbol is rearranged thereon, the CPU 106 advances the processing to Step S102, and in a case where the CPU 106 determines that the rate symbol is not rearranged, the CPU advances the processing to Step S 103. In step S102, the CPU 106 calculates the amount of the award and provides the award. Specifically, the CPU 106 provides an award that equals the award corresponding to the predetermined combination formed by the first symbol group multiplied by the payout rate corresponding to the rate symbol which indicates the payout rate of the award. The payout rate is stored in the payout rate table of the rate symbol (refer to FIG. 10) in correlation with the rate symbols. Subsequently, the CPU 106 terminates the processing, and returns to the next step of the second award providing processing in the basic game processing.

In Step S103, the CPU 106 determines whether or not the predetermined symbol combination has been formed. Specifically, the CPU 106 determines whether or not a combined combination of the rearranged symbols of the first symbol group forming the predetermined combination on the winning line and the rearranged symbols of the second symbol group on the extended line of the winning line matches a predetermined combination based upon the symbol combination table (FIG. 11). In a case where the predetermined combination is formed, the CPU 106 advances the processing to Step S104. In a case where the predetermined combination is not formed, the CPU 106 terminates the processing, and returns to the next step of the second award providing processing of the basic game processing.

In Step S104, the CPU 106 provides the award. Specifically, the CPU 106 reads a payout amount corresponding to the combined combination of the first symbol group and the second symbol group based on the symbol combination table for the combined combination of the first symbol group and the second symbol group. The CPU 106 provides the payout amount. Subsequently, the CPU 106 terminates the processing, and returns to the next step of the second award providing processing of the basic game processing.

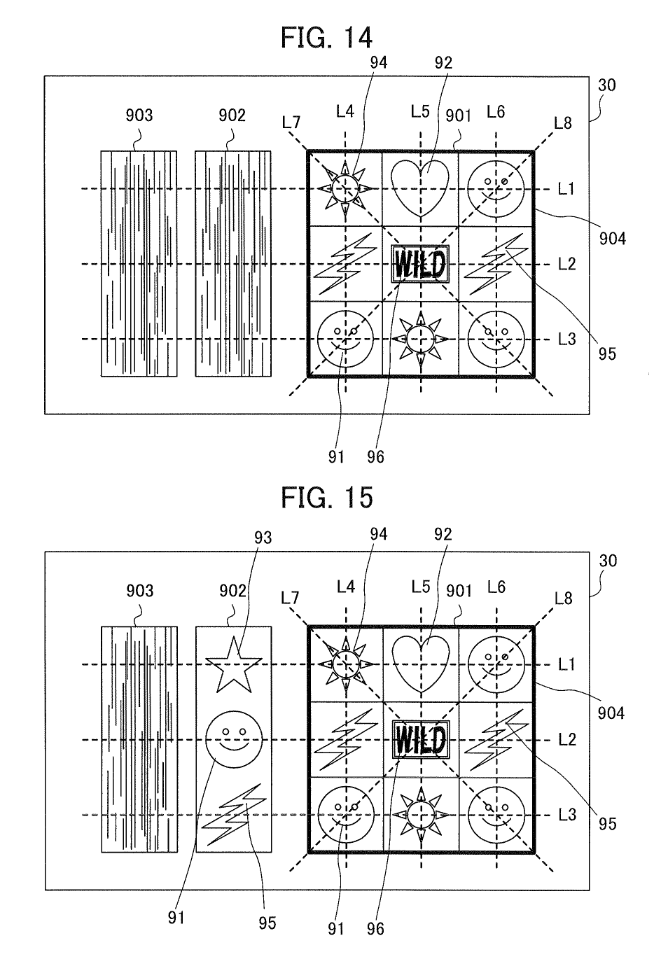

FIG. 14 is a diagram showing a first example of a display screen of a game performed by the gaming machine 10 according to the embodiment of the present invention. The first example shows an example of providing an award for the first symbol group and of further providing an award which equals the award multiplied by the payout rate for the second symbol group.

FIG. 14 shows that the first display area 901 as the first symbol group including 3 rows and 3 columns, and the central reel 902 and the left reel 903 as the second symbol group are disposed on the display area of the liquid crystal display 30. The first display 901 area is shown with a flame image 904. Winning lines L1 to L8 are set in the first display area 901 in advance.

Furthermore, FIG. 14 shows that upon reception of an input of the instruction for starting the game, the basic game is started, then scrolling of the cells 911 to 933 in the first display area 901 is started subsequently, scrolling is stopped and symbols in the cells are rearranged. FIG. 14 shows that as a result of the rearrangement, a thunder symbol 95 formed a predetermined combination together with a wild symbol 96 on a winning line L2. Moreover, FIG. 14 shows that a smile symbol 91 forms a predetermined combination together with a wild symbol 96 on a winning line L8. In addition, FIG. 14 shows that the center reel 902 and the left reel 903 are in the process of rearranging.

FIG. 15 is an example of the display screen continued from FIG. 14.

FIG. 15 shows that the symbols in the first symbol group is stopped, and after the predetermined period of time has elapsed, the symbols in the second symbol group are subsequently stopped and stationary symbols are displayed on the center reel 902 on the liquid crystal display 30. The stationary symbols thus displayed include a star symbol 93, a smile symbol 91 and a thunder symbol 95. Here, neither symbols are a rate symbol which indicates a rate of an award.

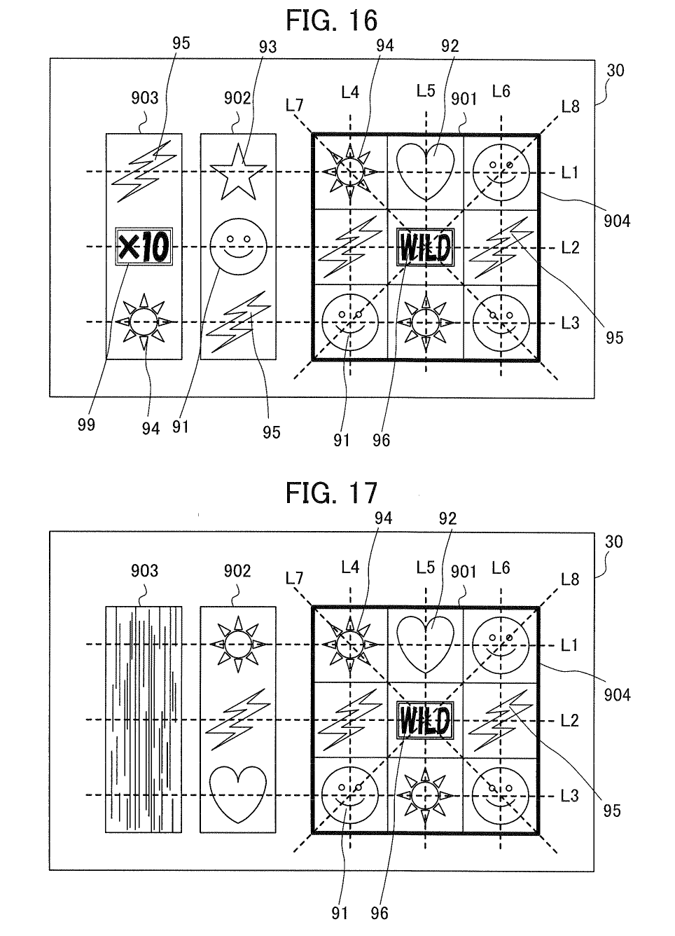

FIG. 16 is an example of the display screen continued from FIG. 15.

FIG. 16 shows that stationary symbols are displayed on the left reel 903 of the second symbol group on the liquid crystal display 30 and the stationary symbols displayed thereon are a thunder symbol 95, the 10 times symbol 99, and a sun symbol 94. FIG. 16 also shows that the “10 times” rate symbol 99 of the second symbol group is rearranged on the extended line of the winning line L2 on which the first symbol group forms the predetermined combination, whereby an award multiplied by 10 is to be provided.

FIG. 17 is a diagram showing the second example of the display screen of the game performed by the gaming machine 10 according to the embodiment of the present invention. The second example is an example showing that an award is provided for the combination formed in the first symbol group and an award is further provided for the combined combination of the first symbol group and the second symbol group.

FIG. 17 shows that upon reception of an input of the instruction for starting the game, the basic game is started, then scrolling of the cells 911 to 933 in the first display area is started, scrolling is subsequently, stopped and symbols in the cells are rearranged. FIG. 17 shows that as a result of the rearrangement, a thunder symbol 95 forms a predetermined combination together with a wild symbol 96 on a winning line L2. Furthermore, FIG. 17 shows that a smile symbol 91 forms a predetermined combination together with a wild symbol 96 on a winning line L8. Moreover, FIG. 17 shows that the symbols in the first symbol group are stopped, after the predetermined period of time has elapsed, the center reel 902 of the second symbol group is subsequently stopped, and the left reel 903 are in the process of rearranging.

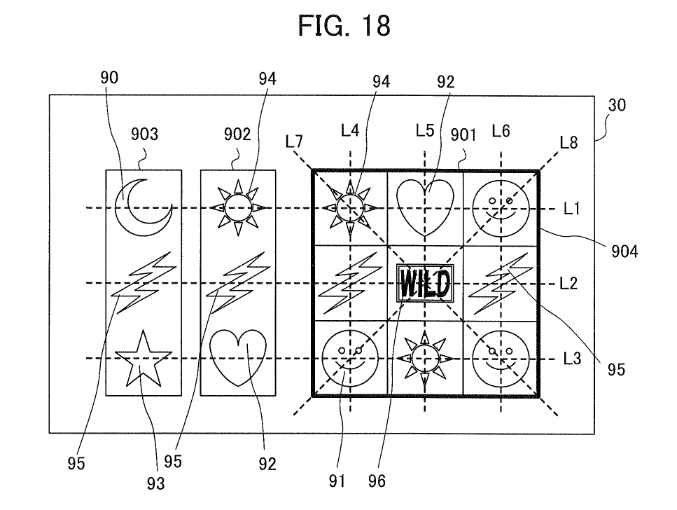

FIG. 18 is an example of the display screen continued from FIG. 17.

FIG. 18 shows that as a result of rearranging symbol within the display area of the liquid crystal display 30, a thunder symbol 95 forms a predetermined combination together with a wild symbol 96 on a winning line L2. Furthermore, FIG. 18 shows that a moon symbol 90, a thunder symbol 95 and a star symbol 93 are rearranged on the left reel 903 and a sun symbol 94, a thunder symbol 95 and a heart symbol 92 are rearranged on the center reel 902 of the second symbol group. Moreover, FIG. 18 shows that since a combined combination of the thunder symbol 95 rearranged on the winning line L2 of the first symbol group and the thunder symbol 95 rearranged on the extended line of the winning line L2 matches the predetermined combination, a predetermined award is additionally provided.

In the present embodiment, although the first symbol group is configured with video reels including 3 rows and 3 columns, and the second symbol group is configured with video reels including 2 columns, the present invention is not limited thereto. For example, the first symbol group may be configured with mechanical reels including 3 rows and 3 columns, and the second symbol group may be configured with mechanical reels including 2 columns. Similarly, the combination of a video reel and a mechanical reel may be utilized as well.

While the embodiments of the gaming machine 10 according to the present invention have been described above, it should be clearly understood that the embodiments in no way restrict the present invention, and that the specific configurations such as the means and members may be modified and altered as suitable. Moreover, it should be understood that the advantages described in association with the embodiments are merely a listing of the most preferred advantages, and that the advantages of the present invention are by no means restricted to those described in connection with the embodiments.

What is claimed is:

1. A gaming machine, comprising:
a display for displaying each of a first symbol group and a second symbol group having a plurality of symbols used in a game, the second symbol group arranged to be adjacent to the first symbol group;
an input device for starting a basic game;
and a controller configured to execute the following processing of:
(a) generating a random number in response to an input to the input device and starting a basic game;
(b) starting scrolling of the symbols displayed on the display;
(c) determining a symbol to stationarily display on the display corresponding to the random number thus generated;
(d) rearranging the symbols thus determined by displaying the symbols stationarily on the display corresponding to the processing of (c);
(e) providing a predetermined award to a player in a case where a combination of the symbols rearranged on a winning line, which combines symbols included in the first symbol group, set on the display in advance matches a predetermined combination; and
(f) in addition to the processing of (e), in a case where a symbol indicating a payout rate of the award among the rearranged symbols in the second symbol group is rearranged on an extended line of the winning line on which the predetermined combination is formed, further providing an award to the player which equals the predetermined award multiplied by the payout rate of the award indicated by the symbol.

2. A gaming machine according to claim 1, wherein:
the controller is configured to further execute the following processing of:
(g) in the rearranging processing of (d), rearranging each of the symbols in the first symbol group, and after a predetermined period of time has elapsed, subsequently rearranging each of the symbols in the second symbol group.

3. A gaming machine according to claim 2, wherein:
the controller is configured to further execute the following processing of:
(h) displaying the first symbol group with a frame image for aiding distinction of symbols on the display.

4. A gaming machine, comprising:
a display for displaying each of a first symbol group and a second symbol group having a plurality of symbols used in a game, the second symbol group arranged to be adjacent to the first symbol group;
an input device for starting a basic game;
and a controller configured to execute the following processing of:
(a) generating a random number in response to an input to the input device and starting a basic game;
(b) starting scrolling of the symbols displayed on the display;
(c) determining a symbol to stationarily display on the display corresponding to the random number thus generated;
(d) rearranging the symbols thus determined by displaying symbols stationarily on the display corresponding to the processing of (c);
(e) providing a predetermined award to a player in a case where a combination of the symbols rearranged on a winning line, which combines symbols included in the first symbol group, set on the display in advance matches a predetermined combination; and
(f) in addition to the processing of (e), in a case where a combined combination of the rearranged symbols of the first symbol group forming the predetermined combination on the winning line and the symbols of the second symbol group rearranged on an extended line of the winning line on which the predetermined combination is formed matches a predetermined combination, further providing a predetermined award to the player.

5. A gaming machine according to claim 4, wherein:
the controller is configured to further execute the following processing of:
(g) in the rearranging processing of (d), rearranging each of the symbols in the first symbol group, and after a predetermined period of time has elapsed, subsequently rearranging each of the symbols in the second symbol group.

6. A gaming machine according to claim 5, wherein:
the controller is configured to further execute the following processing of:
(h) displaying the first symbol group with a frame image for aiding distinction of symbols on the display.
